(19) United States
(12) Patent Application Publication
(10) Pub. No.: US 2018/0074280 A1
(43) Pub. Date: Mar. 15, 2018

(54) STRUCTURE OF SINGLE-LENS WITH MECHANIC ZERO TILT ANGLE AND ADJUSTMENT METHOD THEREOF

(71) Applicant: TOPRAY MEMS INC., Hsinchu City (TW)

(72) Inventors: Chin-Sung Liu, Hsinchu City (TW); Shin-Ter Tsai, Hsinchu City (TW); Chi-Ling Chang, Hsinchu City (TW); Hsiao-Ming Chien, Hsinchu City (TW); Yueh-Lin Hsieh, Hsinchu City (TW)

(21) Appl. No.: 15/344,608

(22) Filed: Nov. 7, 2016

(30) Foreign Application Priority Data
Sep. 12, 2016 (TW) 105129610

(51) Int. Cl. G02B 7/02; H02K 41/035

(52) U.S. Cl. CPC G02B 7/023; H02K 41/0354

(57) ABSTRACT

A single-lens mechanic zero tilt angle adjustment method is disclosed, comprising a preparation step, an adjustment step and an engagement step, wherein preparation step comprising: disposing a lens at a voice coil motor (VCM), with a gap between the bottom of VCM and an engagement surface of an adaptor and the lens optical axis forming a tilt angle with the normal the adaptor plane; adjustment step comprising: adjusting the tilt angle by moving VCM and/or adaptor to zero degree and the optical axis perpendicular to the adaptor plane; and engagement step comprising: adhering the bottom of VCM to an engagement surface of adaptor to obtain a structure of single-lens mechanic zero tilt angle. As such, the adaptor plane is engaged to the image sensor, and the tilt angles between the lens optical axis o and the axis of the image sensor is zero to improve imaging quality.

### CROSS-REFERENCE TO RELATED APPLICATION

The present application is based on, and claims priority form, Taiwan Patent Application No. 105129610, filed Sep. 12, 2016, the disclosure of which is hereby incorporated by reference herein in its entirety.

### TECHNICAL FIELD

The technical field generally relates to a structure of single-lens and adjustment method thereof, and in particular, to a single-lens structure with optical axis forming zero tilt angle with the axis of the mage sensor simultaneously, and adjustment method thereof

### BACKGROUND

As the mobile phone with camera become ubiquitous, the consumers demand ever-increasing higher image quality. The improvement in the quality of imaging comes from the design and manufacturing technology, wherein the relative angle offset (i.e., tilt angle) between the optical axis of a single-lens structure becomes a key factor in the quality of imaging.

Refer to FIG. 1 and FIG. 2. FIG. 1 shows a schematic view of a voice coil motor of a known single-lens structure, and FIG. 2 shows a dissected view of a voice coil motor of a known single-lens structure. The conventional single-lens structure comprises a voice coil motor 1, two lenses (not shown), and an image sensor (not shown). The voice coil motor comprises an outer cover 1A, an upper resilient stripe 1B, a magnet 1C, a coil 1D, a base 1E, a lower resilient stripe 1F and a lower cover 1G. The lens is disposed the base 1E of each voice coil motor 1. The image sensor and the lower covers 1G of the voice coil motor 1 are engaged together.

However, because each component of the voice coil motor has a tolerance, and the assembled voice coil motor generates a tolerance stack up, the tolerances and the tolerance stack up cause the optical axis of the lens non-perpendicular to the bottom surface of the lower cover 1G of the voice coil motor 1. Hence, after the image sensor is engaged to the bottom surface of the lower cover 1G of the voice coil motor 1, the optical axis of the lens forms a tilt angle and is unable to become parallel to the axis of the image sensor, which reduces the imaging quality of the image sensor.

The conventional solution is to improve the precision of the components and reduce the tolerance of each component and the tolerance stack up after assembly, so as to reduce the tilt angle to improve imaging quality.

Although the new precision machinery technologies can improve the component precision, it is still difficult to achieve a complete precision for each component in mass production process. The reason lies in the machine vibration, material variation, abrasion of tools, mold tolerance, temperature variation, residual stress in components, and so on. Therefore, however the precision improves, a zero-tolerance for each component is simply unachievable, not to mention the tolerance stack up after assembly. In other words, the probability of achieving zero tilt angle between the optical axis and the axis of the image sensor is very low and the conventional solution shows limitations. Moreover, the precision improvement often takes longer time to achieve, as well as incurring higher production costs.

### SUMMARY

The primary object of the present invention is to provide a adjustment method for a single-lens structure with mechanic zero tilt angle, for adjusting the tilt angle between the optical axis of the lens and the normal of the adaptor plane to 0° so that the optical axis of lens is parallel to the axis of the image sensor to achieve zero tilt angle between the optical axis of the lens and the axis of the image sensor to improve imaging quality. The adjustment method provides ease to use, high efficiency and low production cost.

Another object of the present invention is to provide a single-lens structure with mechanic zero tilt angle, with the optical axis of the lens perpendicular to the normal of the adaptor plane so that the optical axis of single-lens is parallel to the axis of the image sensor to achieve zero tilt angle between the optical axis of the lens and the axis of the image sensor to improve imaging quality. The structure provides ease in structure, high efficiency and low production cost.

To achieve the aforementioned object, the present invention provides an adjustment method for single-lens structure with mechanic zero tilt angle, comprising the steps of: a preparation step: disposing a lens of the single-lens structure at a voice coil motor (VCM), with a bottom surface of the VCM maintaining a distance to an engagement surface of an adaptor, the optical axis of the lens forming a tilt angle with the normal of the reference plane of the adaptor; an adjustment step: moving the VCM and/or the adaptor to adjust the tilt angle; when the tilt angle being adjusted to 0°, the optical axis of the lens being perpendicular to the reference plane of the adaptor and the VCM and/or the adaptor stopping moving; and an engagement step: adhering the bottom of the VCM to the engagement surface of the adaptor.

Preferably, a sensor is used for sensing the tilt angle; when the sensor sensing that the tilt angle becoming 0°, the VCM and/or the adaptor stops moving.

Preferably, the adaptor is disposed on a surface of a work table, with a mechanical arm moving the VCM and the sensor disposed at the work table; and when the sensor sensing that the tilt angle becoming 0°, the mechanical arm stops moving the VCM.

Preferably, the VCM is disposed on a surface of a work table, with a mechanical arm moving the adaptor and the sensor disposed at the work table; and when the sensor sensing that the tilt angle becoming 0°, the mechanical arm stops moving the adaptor.

Preferably, an adhesive glue is disposed at the bottom of the VCM and the engagement surface of the adaptor to form an adhesive layer.

Preferably, the adhesive glue is applied by coating on the bottom of the VCM and the engagement surface of the adaptor.

The present invention provides the following advantages: by improving the tolerance of each component and the tolerance stack up of the assembled VCM, the adjustment method for single-lens structure with mechanic zero tilt angle of the present invention can adjust the tilt angle to 0°, so that the optical axis of the lens is accurately perpendicular to the reference plane of the adaptor and the optical axis of the lens is accurately parallel to the normal of the reference plane of the adaptor. At this point, after the reference plane of the adaptor is engaged to an image sensor, the normal of the reference plane of the adaptor overlaps the axis of the image sensor so that the optical axes of the lens is parallel to the axis of the image sensor. As such, the present invention can achieve the object of reducing the tilt angle between the optical axis of the lens and the axis of the image sensor to 0°, which improves the imaging quality of the image sensor. The adjustment method is simple, efficient and low cost.

To achieve the aforementioned objects, the present invention provides a single-lens structure with mechanic zero tilt angle, comprising: a lens, a voice coil motor (VCM) and an adaptor; wherein the lens having an optical axis, the VCM having a bottom, and the lens being disposed at the VCM; the adaptor having an engagement surface and a reference plane, with the bottom of the VCM engaged to the engagement surface of the adaptor, and the optical axis of the lens being perpendicular to the reference plane of the adaptor respectively.

Preferably, the single-lens structure further comprises an adhesive layer, disposed between the bottom of the VCM and the engagement surface of the adaptor.

The present invention provides the following advantages: regardless of the tolerance of each component and the tolerance stack up of the assembled VCM, the single-lens structure with mechanic zero tilt angle of the present invention can achieve the object that the optical axis of the lens is accurately perpendicular to the reference plane of the adaptor and the optical axis of the lens overlaps the normal of the reference plane of the adaptor and the tilt angle is 0°. After the reference plane of the adaptor is engaged to an image sensor, the normal of the reference plane of the adaptor overlaps the axis of the image sensor so that the optical axes of the two lenses are parallel to the axis of the image sensor. As such, the present invention can achieve the object of reducing the tilt angles between the optical axes of the two lenses and the axis of the image sensor to 0°, which improves the imaging quality of the image sensor. The structure is simple and low cost.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a voice coil motor of a known single-lens structure;

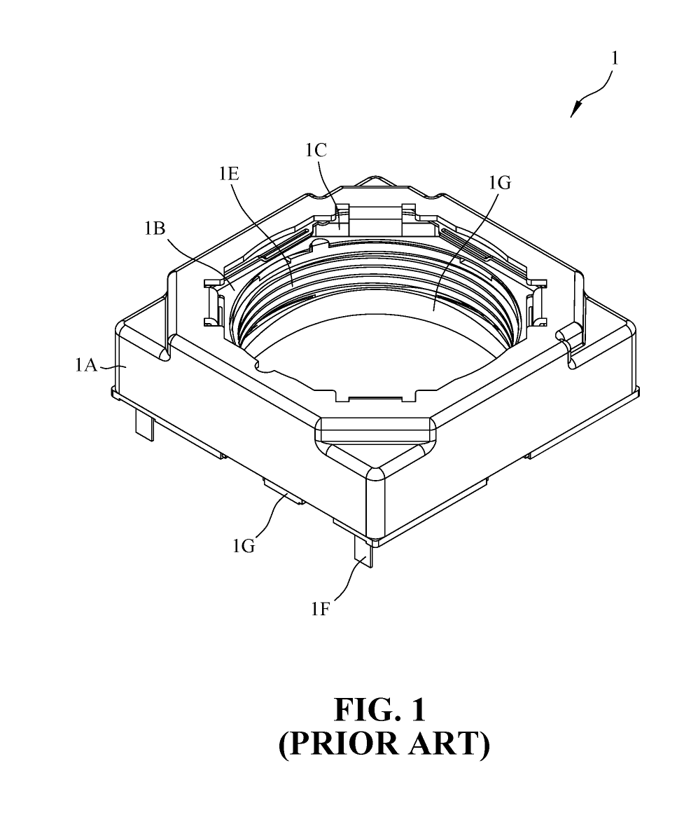

FIG. 2 shows a dissected view of a voice coil motor of a known single-lens structure;

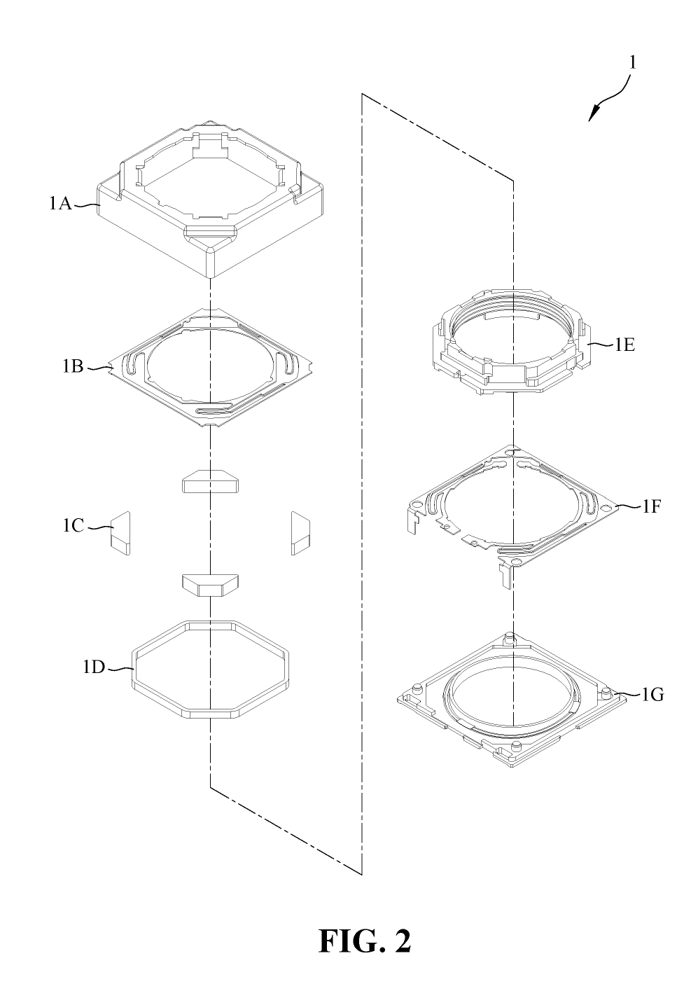

FIG. 3 shows a schematic view of the flowchart of the adjustment method for single-lens structure with mechanic zero tilt angle of the present invention;

FIG. 4 shows a schematic view of the preparation step of the adjustment method for single-lens structure with mechanic zero tilt angle of the present invention;

FIG. 5 shows a schematic view of the adjustment step of the adjustment method for single-lens structure with mechanic zero tilt angle of the present invention;

FIG. 6 shows a schematic view of the engagement step of the adjustment method for single-lens structure with mechanic zero tilt angle of the present invention;

FIG. 7 shows a schematic view of the single-lens structure with mechanic zero tilt angle of the present invention;

FIG. 8 shows a dissected view of the single-lens structure with mechanic zero tilt angle of the present invention; and

FIG. 9 shows a schematic view of an image sensor engaged to the single-lens structure with mechanic zero tilt angle of the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

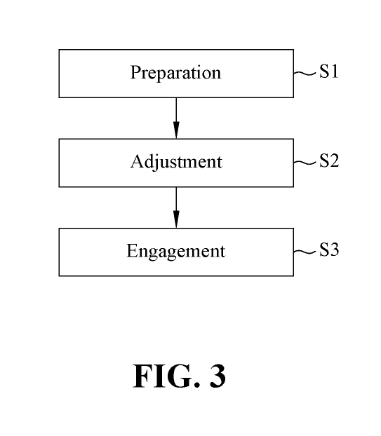

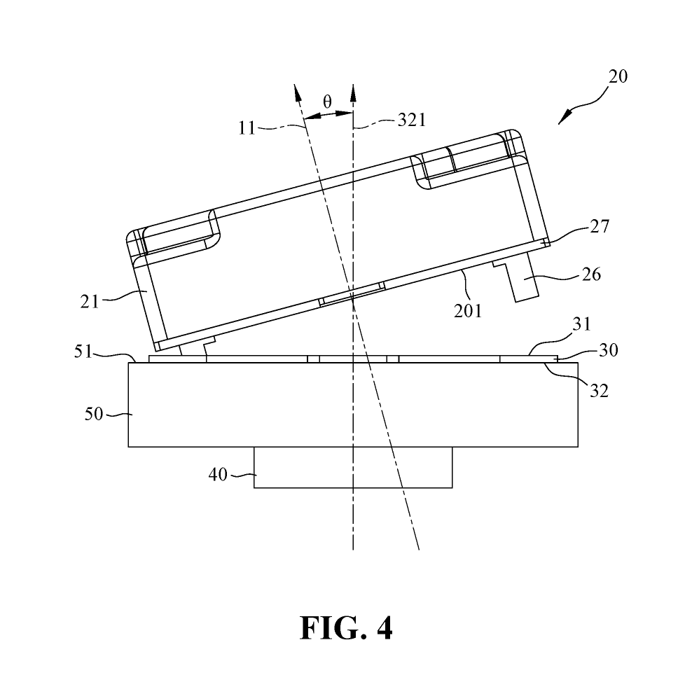

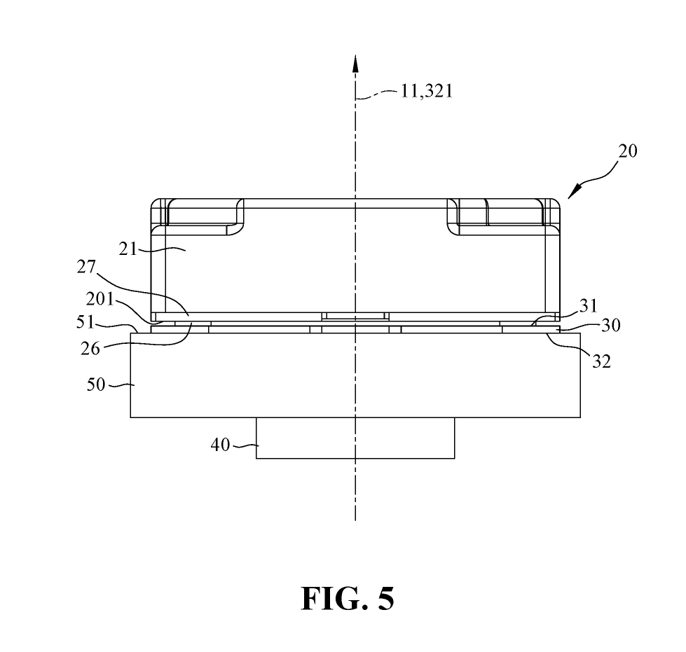

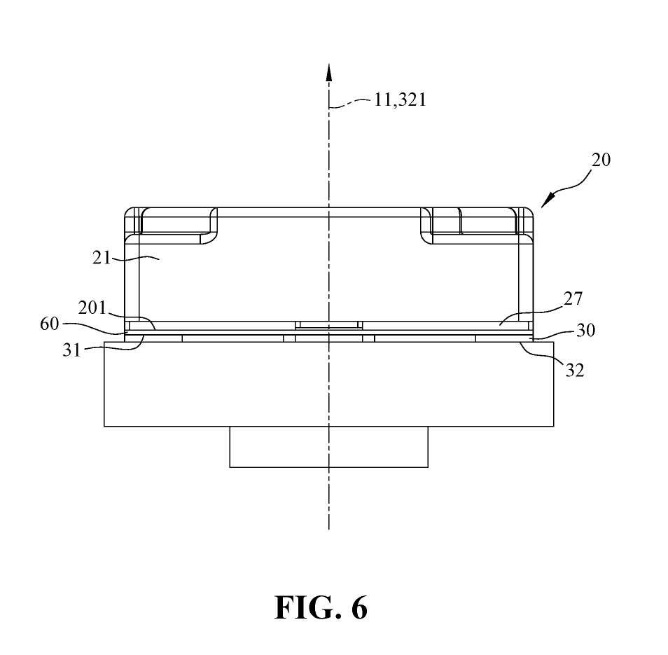

Refer to FIGS. 3-6. FIG. 3 shows a schematic view of the flowchart of the adjustment method for single-lens structure with mechanic zero tilt angle of the present invention; FIG. 4 shows a schematic view of the preparation step of the adjustment method for single-lens structure with mechanic zero tilt angle of the present invention; FIG. 5 shows a schematic view of the adjustment step of the adjustment method for single-lens structure with mechanic zero tilt angle of the present invention; and FIG. 6 shows a schematic view of the engagement step of the adjustment method for single-lens structure with mechanic zero tilt angle of the present invention. The adjustment method for single-lens structure with mechanic zero tilt angle comprises the steps of:

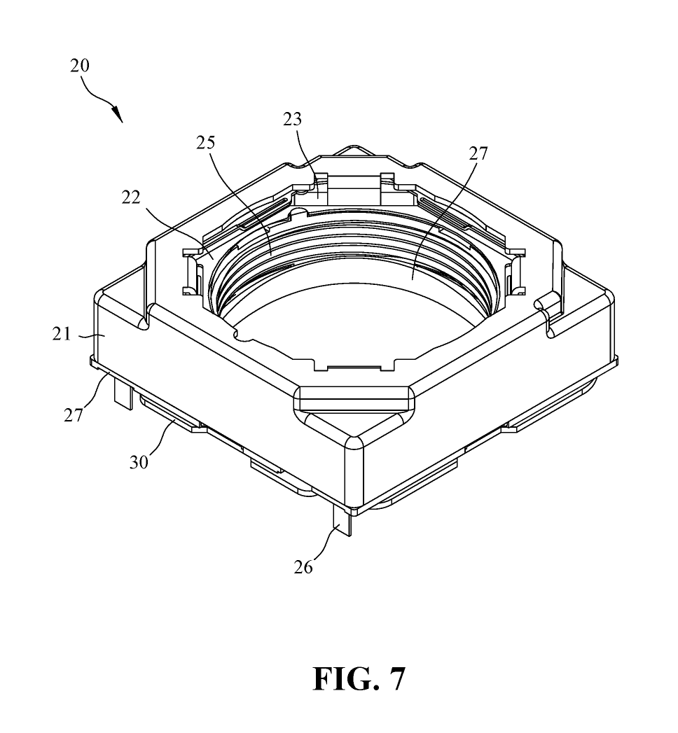

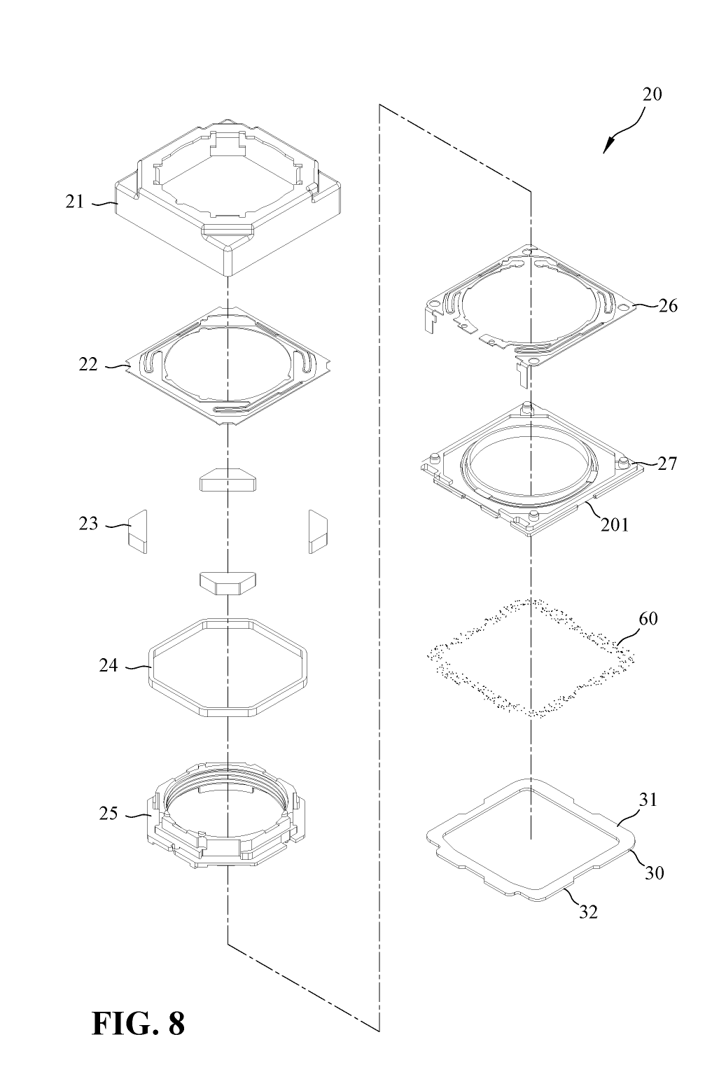

Preparation S1: disposing a lens (not shown) of the single-lens structure at a voice coil motor (VCM) 20, with a bottom surface 201 of the VCM 20 maintaining a distance to an engagement surface 31 of an adaptor 30, the optical axis 11 of the lens forming a tilt angle θ with the normal 321 of the reference plane 32 of the adaptor 30, as shown in FIG. 3 and FIG. 4. Specifically, the VCM 20″ comprises an outer cover 21, an upper resilient stripe 22, four magnets 23, a coil 24, a base 25, a lower resilient stripe 26 and a lower cover 27. The bottom of the lower cover 27 is defined as the bottom 201 of the VCM 20, as shown in FIG. 7 and FIG. 8. Because the VCM 20 and the components are of known technology, the connection and function of the components will not be described here.

Adjustment S2: moving the VCM 20 and/or the adaptor 30 to adjust the tilt angle θ to 0°; when the tilt angle θ being adjusted to 0°, the optical axis 11 of the lens being perpendicular to the reference plane 32 of the adaptor 30 and the VCM 20 and/or the adaptor 30 stopping moving, as shown in FIG. 3, and FIG. 5. In other words, the tilt angle θ being 0° means that the optical axis 11 of the lens overlaps the normal 321 of the reference plane 32 of the adaptor 30. The moving refers to the motion in the six degrees of freedom in the three dimensional space, that is, an object moving along the X-axis, Y-axis and Z-axis, and rotating around the X-axis, Y-axis and Z-axis. Accordingly, in this step, the VCM 20 and/or the adaptor 30 moves along the X-axis, Y-axis and Z-axis, and rotates around the X-axis, Y-axis and Z-axis so as to adjust the tilt angle θ. Preferably, a sensor 40 is used for sensing the tilt angle θ when the sensor 40 sensing that the tilt angle θ becoming 0° (i.e., the optical axis 11 of the lens is perpendicular to the reference plane 32 of the adaptor 30, and the optical axis 11 of the lenses overlaps the normal 321 of the reference plane 32 of the adaptor 30), the sensor 40 will propagate the sensing result to a control device (not shown), and the control device will control the VCM 20 and/or the adaptor 30 to stop moving. As such, the optical axis 11 of the lens maintains in a state of being perpendicular to the reference plane 32 of the adaptor 30. In the present embodiment, the adaptor 30 is disposed on a surface 51 of a work table 50, with a mechanical arm (not shown) moving the VCM 20 and the sensor 40 disposed at the work table 50; and when the sensor 40 sensing that the tilt angle θ becoming 0° (i.e., the optical axis 11 of the lens is perpendicular to the reference plane 32 of the adaptor 30, and the optical axis 11 of the lens overlaps the normal 321 of the reference plane 32 of the adaptor 30), the sensor 40 will propagate the sensing result to a control device, and the control device will control the mechanical arm to stop moving the VCM 20. In other embodiments, the VCM 20 is disposed on a surface 51 of a work table 50, with a mechanical arm (not shown) moving the adaptor 30 and the sensor 40 disposed at the work table 50; and when the sensor 40 sensing that the tilt angle θ becoming 0° (i.e., the optical axis 11 of the lens is perpendicular to the reference plane 32 of the adaptor 30, and the optical axis 11 of the lens overlaps the normal 321 of the reference plane 32 of the adaptor 30), the sensor 40 will propagate the sensing result to a control device, and the control device will control the mechanical arm to stop moving the adaptor 30.

Engagement S3: adhering the bottom 201 of the VCM 20 to the engagement surface 31 of the adaptor 30, as shown in FIG. 3 and FIG. 6. Moreover, an adhesive glue is disposed at the bottom 201 of the VCM 20 and the engagement surface 31 of the adaptor 30 to form an adhesive layer 60. Preferably, the adhesive glue is applied by coating on the bottom 201 of the VCM 20 and the engagement surface 31 of the adaptor 30.

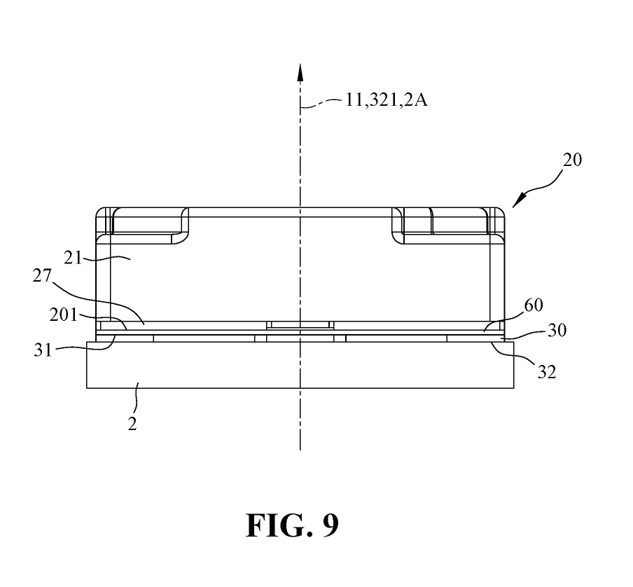

As such, regardless of the tolerance of each component and the tolerance stack up of the assembled VCM 20, the adjustment method for single-lens structure with mechanic zero tilt angle of the present invention can adjust the tilt angle θ to 0°, so that the optical axes 11, 11′ of the lens is accurately perpendicular to the reference plane 32 of the adaptor 30 and the optical axis 11 of the lens overlaps the normal 321 of the reference plane 32 of the adaptor 30 to obtain the first embodiment of a single-lens structure with mechanic zero tilt angle, as shown in FIG. 7 and FIG. 8. Referring to FIG. 9, at this point, the reference plane 32 of the adaptor 30 is engaged to an image sensor 2, the normal 321 of the reference plane 32 of the adaptor 30 overlaps the axis 2A of the image sensor 2 so that the optical axis 11 the lens is parallel to the axis 2A of the image sensor 2. As such, the present invention can achieve the object of reducing the tilt angles between the optical axis 11 of the lens and the axis 2A of the image sensor to 0°, which improves the imaging quality of the image sensor. The adjustment method is simple, efficient and low cost.

Refer to FIGS. 7-9. FIG. 7 shows a schematic view of the single-lens structure with mechanic zero tilt angle of the present invention; FIG. 8 shows a dissected view of the single-lens structure with mechanic zero tilt angle of the present invention; and FIG. 9 shows a schematic view of an image sensor engaged to the single-lens structure with mechanic zero tilt angle of the present invention. The single-lens structure with mechanic zero tilt angle of the present invention comprises: a lens (not shown), a voice coil motors (VCM) 20, an adaptor 30 and an adhesive layer 60.

The lens has an optical axis 11.

The VCM 20 has a bottom 201, and the lens is disposed at the VCM 20. Specifically, the VCM 20 comprises an outer cover 21, an upper resilient stripe 22, four magnets 23, a coil 24, a base 25, a lower resilient stripe 26 and a lower cover 27. The bottom of the lower cover 27 is defined as the bottom 201 of the VCM 20.

The adaptor 30 has an engagement surface 31 and a reference plane 32. The adhesive layer 60 is disposed between the bottom 201 of the VCM 20 and the engagement surface 31 of the adaptor 30 so that the bottom 201 of the VCM 20 are fixed to the engagement surface 31 of the adaptor 30; wherein the optical axis 11 of the lens is perpendicular to the reference plane 32 of the adaptor 30 respectively. In other words, the optical axis 11 of the lens overlaps the normal 321 of the reference plane 32 of the adaptor 30. Therefore, the tilt angle θ between the optical axis 11 of the lens and the normal 321 of the reference plane 32 of the adaptor 30 is 0°.

As such, regardless of the tolerance of each component and the tolerance stack up of the assembled VCM 20, the first embodiment of the single-lens structure with mechanic zero tilt angle of the present invention makes the optical axis 11 of the lens to become accurately perpendicular to the reference plane 32 of the adaptor 30 and the optical axis 11 of the lens overlaps the normal 321 of the reference plane 32 of the adaptor 30, and the tilt angle θ between the optical axis 11 of the lens and the normal 321 of the reference plane 32 of the adaptor 30 is 0°. When the reference plane 32 of the adaptor 30 is engaged to an image sensor 2, the normal 321 of the reference plane 32 of the adaptor 30 overlaps the axis 2A of the image sensor 2 so that the optical axis 11 of the lens overlaps the axis 2A of the image sensor 2, as shown in FIG. 9. As such, the present invention can achieve the object of the tilt angles between the optical axis 11 of the lens and the axis 2A of the image sensor being 0°, which improves the imaging quality of the image sensor. The structure is simple and low in cost.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An adjustment method for single-lens structure with mechanic zero tilt angle, comprising the steps of:
a preparation step: disposing a lens of the single-lens structure at a voice coil motor (VCM), with a bottom surface of the VCM maintaining a distance to an engagement surface of an adaptor, the optical axis of the lens forming a tilt angle with the normal of the reference plane of the adaptor;
an adjustment step: moving the VCM and/or the adaptor to adjust the tilt angle to 0°, the optical axis of the lens being perpendicular to the reference plane of the adaptor and the VCM and/or the adaptor stopping moving; and
an engagement step: adhering the bottom of the VCM to the engagement surface of the adaptor.

2. The adjustment method for single-lens structure with mechanic zero tilt angle as claimed in claim 1, wherein a sensor is used for sensing the tilt angle; when the sensor sensing that the tilt angle becoming 0°, the VCM and/or the adaptor stops moving.

3. The adjustment method for single-lens structure with mechanic zero tilt angle as claimed in claim 2, wherein the adaptor is disposed on a surface of a work table, with a mechanical arm moving the VCM and the sensor disposed at the work table; and when the sensor sensing that the tilt angle becoming 0°, the mechanical arm stops moving the VCM.

4. The adjustment method for single-lens structure with mechanic zero tilt angle as claimed in claim 2, wherein the VCM is disposed on a surface of a work table, with a mechanical arm moving the adaptor and the sensor disposed at the work table; and when the sensor sensing that the tilt angle becoming 0°, the mechanical arm stops moving the adaptor.

5. The adjustment method for single-lens structure with mechanic zero tilt angle as claimed in claim 1, wherein an adhesive glue is disposed at the bottom of the VCM and the engagement surface of the adaptor to form an adhesive layer.

6. The adjustment method for single-lens structure with mechanic zero tilt angle as claimed in claim 5, wherein the adhesive glue is applied by coating on the bottom of the VCM and the engagement surface of the adaptor.

7. A single-lens structure with mechanic zero tilt angle, comprising:
a lens, having an optical axis;
a voice coil motor (VCM), having a bottom, and the lens being disposed at the VCM; and
an adaptor, having an engagement surface and a reference plane, with the bottom of the VCM engaged to the engagement surface of the adaptor, and the optical axis of the lens being perpendicular to the reference plane of the adaptor.

8. The single-lens structure with mechanic zero tilt angle as claimed in claim 7, wherein the single-lens structure further comprises an adhesive layer, disposed between the bottom of the VCM and the engagement surface of the adaptor.
